(19) United States
(12) Patent Application Publication
(10) Pub. No.: US 2025/0328006 A1
(43) Pub. Date: Oct. 23, 2025

(54) IMAGING ELEMENT CLEANING APPARATUS AND CALIBRATION DEVICE USEFUL WITH SAME

(71) Applicant: ClearCam, Inc., Austin, TX (US)

(72) Inventors: Tremaan Alexander Spearman-White, Austin, TX (US); Alexander Ross Cohen, Austin, TX (US); David James Oh, Austin, TX (US)

(73) Assignee: ClearCam, Inc., Austin, TX (US)

(21) Appl. No.: 18/643,942

(22) Filed: Apr. 23, 2024

(51) Int. Cl. G02B 27/00; G02B 23/24; H04N 23/50

(52) U.S. Cl. CPC G02B 27/0006; G02B 23/243; H04N 23/555

(57) ABSTRACT

Embodiments of the disclosures made herein are directed to providing an effective and reliable approach for cleaning an exposed surface of an imaging element (e.g., a lens) of apparatuses including but not limited to medical imaging instruments such as endoscopes and laparoscopes and the like. In the case of medical imaging instruments, cleaning apparatuses configured in accordance with embodiments the disclosures made herein can be cleaned while the distal end portion of the endoscope is in vivo. Such apparatuses have a cleaning member incorporated therein (e.g., a resilient polymeric wiper, a sponge, an absorbent pad or the like) that is used for cleaning the exposed surface of the imaging element. The apparatus is preferably adapted for being mounted on imaging apparatus but can also be entirely or partially integral with one or more components of the imaging apparatus or system of which it is a component.

### FIELD OF THE DISCLOSURE

The disclosures made herein relate generally to cleaning of devices that utilize a remote imaging element for visualization of structures at a concealed site and, more particularly, to an imaging element cleaning apparatus for cleaning an exposed surface of the imaging element while the exposed surface is located within a concealed site such as an in vivo human or animal environment.

### BACKGROUND

Surgical procedures utilizing in vivo visualization of target surgical sites are well known as a form of a concealed operation site. Examples of these surgeries include, but are not limited to, endoscopic surgery, laparoscopic surgery, thoracoscopic surgery and the like. These surgical procedures all utilize a surgical instrument having an integrated visualization device for providing in vivo visualization of a target surgical site within a surgical space of the patient. Although it is common for the surgical instrument to be referred to in the context of the specific type of surgical procedure (e.g., endoscope for endoscopic surgery, laparoscope for laparoscopic surgery, and the like), these surgical instruments are generally referred to herein as an “endoscope” and may be in the form of a scope having an integral video camera (i.e., a videoscope).

As shown in FIG. 1, an endoscope 1 used in these surgical procedures is characterized as having a user interface portion 5 and an extension portion 10 connected at its proximate end 15 to the user interface portion 5. Scopes for endoscopic surgery generally have an extension portion that is substantially flexible, whereas scopes for other types of surgical procedures—e.g., for laparoscopic surgery, as shown in FIG. 1—generally have an extension portion 10 that is substantially rigid. The extension portion 10 has an imaging element 20 such as a lens at its distal end portion 25. The imaging element 20 can have an exposed surface that is typically flush with or that defines an end face of the extension portion 10. However, in some embodiments, the imaging element 20 may be recess within or protruding from an end face of the extension portion 10. The imaging element 20 may be connected to an optical fiber or other image transmitting element that is internal to the endoscope 1. The optical fiber or other image transmitting element may extend along the length of the extension portion 10 and terminates at signal processing unit (not shown) within the endoscope 1 (e.g., within a housing defining the user interface portion 5). The imaging element 20 may be that of a camera such as where the endoscope 1 is embodied as a videoscope.

During a surgical procedure using an endoscope, the exposed surface of the imaging element thereof may become compromised from an optical standpoint due to one or more in vivo scenarios. Examples of these scenarios include the exposed surface of the imaging element becoming fogged with moisture within the surgical space, or the exposed surface of the imaging element may be smeared by blood or other bodily fluids or tissues (e.g., interstitial fluid, fat tissue or the like). Currently, there are two primary different endoscope cleaning methods that are commonly utilized. The first of these cleaning methods is to remove the endoscope from the body, wipe the imaging element clean, and reinsert the endoscope into the body. This method, though effective, is time consuming and causes the surgeon to lose visual of the surgical site, which can be considered dangerous, as surgical instruments typically remain inside the body. This method can also subject the patient to a higher risk of infection. The second of these cleaning methods is to wipe the exposed surface of the imaging element upon a nearby organ or tissue in vivo. Although the endoscope remains inside the body, takes less time to clean and does not potentially compromise the surgical site, this method is often not sufficiently effective either due to the “cleaning” surface not providing effective cleaning performance or simply further compromising the exposed surface of the imaging element. Also, when using either of these cleaning methods, the surgeon must undesirably spend time relocating the endoscope back to the surgical site after cleaning the imaging element.

At a minimum, current approaches for cleaning the exposed surface of the imaging element can be a hindrance and an annoyance for surgeons and may offer poor cleaning performance. Additionally, the action of cleaning the exposed surface of the imaging element increases the length of time a surgical procedure takes, thereby decreasing the amount of operating room (OR) time available to the hospital or other type of surgical facility. It is also costly for surgical facilities, patients, and insurance companies due to wasted time, and possibly surgical complications and post-surgical infection rates. Additionally, as patients undergo longer procedures, their time spent under anesthesia increases which has been shown to correlate to a rise in surgical complication rates and post-surgical infection rates. Thus, the added time associated with current commonly used approaches for cleaning the exposed surface of the imaging element is not only a hindrance, but also potentially medically and financially costly.

Thus, to maintain required visualization of target surgical sites, it is desirable to clean an exposed surface of an imaging element of a device while the distal end portion of the device remains in a concealed operation site (e.g., an endoscope in vivo). Known methods and devices that are intended to provide for cleaning of a surface of such devices when still within the concealed operation site (e.g., an endoscope in vivo) have one or more shortcomings (e.g., lack efficacy, interfere with the surgical procedure, require significant alteration to a surgeon's preferred surgical technique, etc.). Therefore, an effective, efficient, simple and reliable approach for enabling an exposed surface of an imaging element of device (e.g., an endoscope) to be cleaned while the distal end portion of apparatus is still within the concealed operation site (e.g., in vivo) would be advantageous, desirable and useful.

### SUMMARY OF THE DISCLOSURE

Embodiments of the disclosures made herein are directed to providing an effective and reliable approach for allowing an exposed surface of an imaging element (e.g., a lens) of a device (e.g., an endoscope) be cleaned while the distal end portion of the device is within a concealed operational site (e.g., in vivo). More specifically, one or more embodiments of the disclosures made herein provide an apparatus for use with an endoscope utilized in one or more types of surgical procedures (e.g., endoscopic surgery, laparoscopic surgery, thoracoscopic surgery and the like), The apparatus incorporates a cleaning member (e.g., a resilient polymeric wiper, a sponge, an absorbent pad or the like) used for cleaning the exposed surface of the imaging element of the device while the imaging element is within the concealed operation site. The apparatus is preferably adapted for having the device mounted thereon but can also be can be entirely or partially integral with one or more components of the device (e.g., a robotic arm configured for carrying, operating and manipulating an endoscope).

Cleaning apparatuses in accordance with one or more embodiments of the disclosures made herein can be configured to be used with commercially available endoscopes. Dimensions of such endoscopes are either published or otherwise publicly determinable. As a result of knowing the dimensions of the target endoscopes intended for use with a cleaning apparatus in accordance with one or more embodiments of the present, cleaning apparatuses configured in accordance with one or more embodiments of the disclosures made herein can be engineered device-specific. Thus, engagement of a device such as an endoscope on an intended one of these device-specific cleaning apparatuses preferably results in the device having a seated configuration on the cleaning apparatus exhibiting a high level of dimensional precision between the device and the cleaning apparatus.

Although such high level of dimensional precision is exhibited, both the device and the cleaning apparatus have respective manufacturing tolerances that can influence the efficiency, effectiveness and predictability by which the cleaning member cleans the imaging element. For example, in view of cleaning apparatuses configured in accordance with embodiments of the disclosures made herein relying upon contact with portions of the device comprising the imaging element (e.g., direct surface contact between the imaging element and the cleaning member), these manufacturing tolerances can influence a degree of force and/or deflection that the cleaning member exhibits as it comes into contact with the imaging element and thereby influence cleaning performance. Similarly, in some situations (e.g., rate of speed by which the cleaning member is brought into contact with the imaging element, direction of motion of the cleaning member and the like), other consideration can also influence the degree of force and/or deflection that the cleaning member exhibits as it comes into contact with the imaging element. Still further, some compatible devices (e.g., of different brands, model, or combinations thereof) may have nominally different dimensions as related to axial positioning between the cleaning member and the imaging element.

Advantageously, cleaning apparatuses configured in accordance with embodiments of the disclosures made herein may include a mechanism for selectively adjusting the axial position of the cleaning member—i.e., an axial position adjuster. The axial position of the cleaning member is relative to the device (e.g., the distal end portion of the extension portion of the endoscope). In most instances, the axial position will be relative to a face of an imaging element exposed at an end face of the extension portion. Through such adjustment of the axial position of the cleaning member, a user may alter the degree of force and/or deflection that the cleaning member exhibits as it comes into contact with the end portion of the endoscope and/or imaging element, thereby optimizing cleaning functionality.

In one or more embodiments of the disclosures made herein, an imaging element cleaning apparatus comprises a chassis adapted for having an endoscope engaged therewith, a cleaning member at a distal end portion of the chassis, and a cleaning member controller at a proximate end portion of the chassis. The chassis includes an endoscope receptacle having an interior space configured to have a mating portion of the endoscope disposed therein. The chassis includes an endoscope retention member selectively moveable between an endoscope locking position to engage a first mating portion of the endoscope for maintaining the endoscope in an axially seated configuration within the endoscope receptacle and an endoscope unlocking position to disengage from the first mating portion of the endoscope for permitting the endoscope to be removed from being axially seated within the endoscope receptacle. The chassis includes an endoscope anti-rotation structure that engages a second mating portion of the endoscope to secure the endoscope in a prescribed rotationally indexed position relative to the chassis when the endoscope in the axially seated configuration within the endoscope receptacle. The cleaning member controller is coupled to the chassis and to the cleaning member for enabling selective movement of the cleaning member relative to the chassis.

In one or more embodiments of the disclosures made herein, an imaging element cleaning apparatus system comprises a cleaning apparatus calibration device and an imaging element cleaning apparatus. The cleaning apparatus calibration device has a chassis, a setting indicia body fixedly attached to the chassis, and an indicator body moveably attached to at least one of the setting indicia body and the chassis for enabling the indicator body to move relative to the setting indicia body. The chassis enables a distal end portion of an extension portion of an endoscope to engage an imaging element engagement portion of the indicator body when a reference surface of the endoscope is engaged with a mating reference surface of the chassis to thereby cause the indicator body to move to a corresponding position designating a respective one of a plurality of setting indicum on the setting indicia body. The imaging element cleaning apparatus includes a chassis adapted for having the endoscope engaged therewith, a cleaning member at a distal end portion of the chassis, and a cleaning member controller at a proximate end portion of the chassis. The cleaning member controller is coupled to the chassis and to the cleaning member for enabling selective movement of the cleaning member relative to the chassis. The cleaning member controller includes a first cleaning member control mechanism and a second cleaning member control mechanism. The first cleaning member control mechanism is translatably attached to the chassis to enable movement of the cleaning member between a stowed position and a use position relative to the location adjacent to the imaging element of the endoscope when the endoscope is mounted on the chassis. The first cleaning member control mechanism is rotatably attached to the chassis to enable movement of the cleaning member into and away from contact with the imaging element. The second cleaning member control mechanism includes a control body rotatably attached to the first cleaning member control mechanism to provide for axial adjustment of the cleaning member relative to the chassis. The control body includes a set of markings each identifying a respective axial position of the cleaning member relative to the chassis. Each of the marking corresponds to a respective one of the setting indicum on the setting indicia body. The control body is rotatable to a plurality of cleaning member axial adjustment positions each corresponding to a respective one of the markings becoming aligned with a reference indicator on the chassis.

In one or more embodiments, the endoscope receptacle includes an upper end portion and a bottom end portion, the endoscope retention member is located adjacent to the upper end portion, and the endoscope anti-rotation structure is located adjacent to the bottom end portion.

In one or more embodiments, the endoscope anti-rotation structure at least partially defines the bottom end of the endoscope receptacle

In one or more embodiments, an endoscope engagement portion of the endoscope retention member is located within an interior space of the endoscope receptacle.

In one or more embodiments, the chassis includes an elongated body having a central passaged adapted to receive an extension portion of the endoscope therein and the endoscope retention member rotates about a centerline longitudinal axis of central passage of the elongated body.

In one or more embodiments, the endoscope anti-rotation structure at least partially defines the bottom end of the endoscope receptacle and the bottom end of the endoscope receptacle includes a seating surface that engages the first mating portion of the endoscope to define the axially seated configuration of the endoscope relative to the chassis.

In one or more embodiments, the endoscope anti-rotation structure at least partially defines a bottom end of the endoscope receptacle, the bottom end of the endoscope receptacle includes a seating surface that engages the first mating portion of the endoscope to define the axially seated configuration of the endoscope relative to the chassis, and an endoscope engagement portion of the endoscope retention member is located within an interior space of the endoscope receptacle.

In one or more embodiments, the endoscope anti-rotation structure at least partially defines a bottom end of the endoscope receptacle, the bottom end of the endoscope receptacle includes a seating surface that engages the first mating portion of the endoscope to define the axially seated configuration of the endoscope relative to the chassis, and an endoscope engagement portion of the endoscope retention member is located within an interior space of the endoscope receptacle.

In one or more embodiments, the cleaning member controller includes a first cleaning member control mechanism and a second cleaning member control mechanism, the first cleaning member control mechanism is translatably attached to the chassis to enable movement of the cleaning member between a stowed position and a use position relative to the location adjacent to the imaging element of the endoscope when the endoscope is mounted on the chassis, the first cleaning member control mechanism is rotatably attached to the chassis to enable movement of the cleaning member into and away from contact with the imaging element, and the second cleaning member control mechanism includes a control body rotatably attached to the first cleaning member control mechanism to provide for axial adjustment of the cleaning member relative to the distal end portion of the chassis.

In one or more embodiments, the control body includes a set of markings each identifying a respective axial position of the cleaning member relative to the distal end portion of the chassis and the control body is rotatable to a plurality of axial adjustment positions each corresponding to a respective one of the markings becoming aligned with a reference indicator on the chassis.

In one or more embodiments, the chassis includes a longitudinal reference axis and an imaging element contacting surface of the imaging element engagement portion is located on the longitudinal reference axis.

In one or more embodiments, the chassis includes a sheath having a central passage adapted to receive an extension portion of the endoscope therein and an imaging element contacting surface of the imaging element engagement portion is located one of within the central passage of the sheath and adjacent to an open end of the sheath through which the central passage of the sheath is accessible.

In one or more embodiments, the chassis includes an endoscope receptacle having an interior space configured to have a mating portion of the endoscope disposed therein, the chassis includes an endoscope retention member selectively moveable between an endoscope locking position to engage a first mating portion of the endoscope for maintaining the endoscope in an axially seated configuration within the endoscope receptacle and an endoscope unlocking position to disengage from the first mating portion of the endoscope for permitting the endoscope to be removed from being axially seated within the endoscope receptacle, and the chassis includes an endoscope anti-rotation structure that engages a second mating portion of the endoscope to secure the endoscope in a rotationally indexed position relative to the chassis when the endoscope in the axially seated configuration within the endoscope receptacle.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a perspective view showing a prior art endoscope, which is embodied as a wireless videoscope.

FIG. 2 is a first perspective view showing an imaging element cleaning apparatus in accordance with one or more embodiments of the disclosures made herein, where a cleaning member of the imaging element cleaning apparatus is in a use position and a control body of a first cleaning member control mechanism of the imaging element cleaning apparatus is in a corresponding cleaning member use position.

FIG. 3 is a second perspective view of the imaging element cleaning apparatus shown in FIG. 2, where the cleaning member is in a stowed position and the control body is in a corresponding cleaning member stow position.

FIG. 4 is an enlarged partial view of the imaging element cleaning apparatus shown in FIG. 2.

FIG. 5 is an end view of the imaging element cleaning apparatus shown in FIG. 2.

FIG. 6 is partial cross-sectional view taken along the line 6-6 in FIG. 5.

FIG. 7 is partial perspective view showing an endoscope retention member of the endoscope cleaning apparatus relative to a mating portion of the endoscope of FIG. 1

FIG. 8 is side view of a cleaning apparatus calibration device in accordance with one or more embodiments of the disclosures made herein.

FIG. 9 is partial cross-sectional view taken along a longitudinal centerline axis of the cleaning apparatus calibration device shown in FIG. 8, where an indicator body of the cleaning apparatus calibration device is not cross-sectioned.

FIG. 10 is the partial cross-sectional view of the cleaning apparatus calibration device shown in FIG. 8 with the prior art endoscope shown in FIG. 1 engaged in a seated configuration therewith.

### DETAILED DESCRIPTION

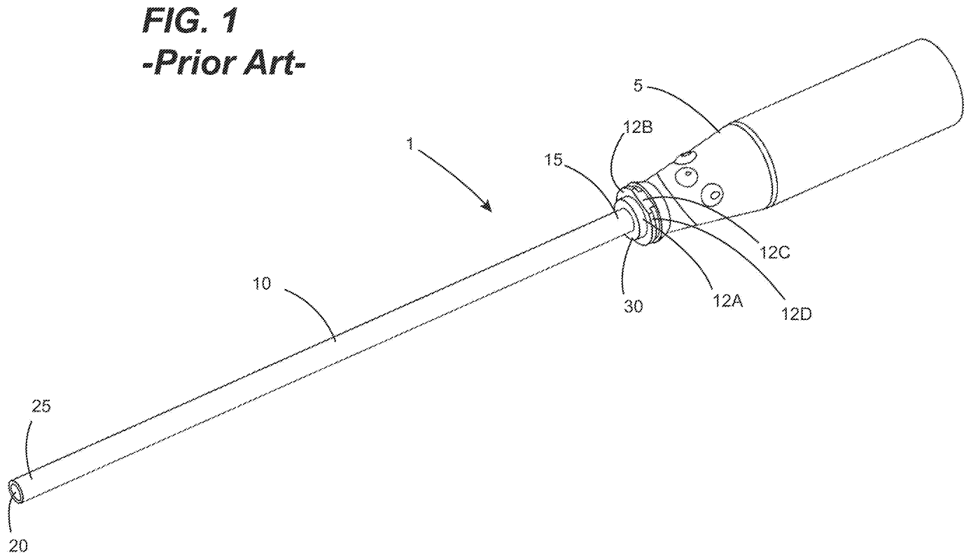

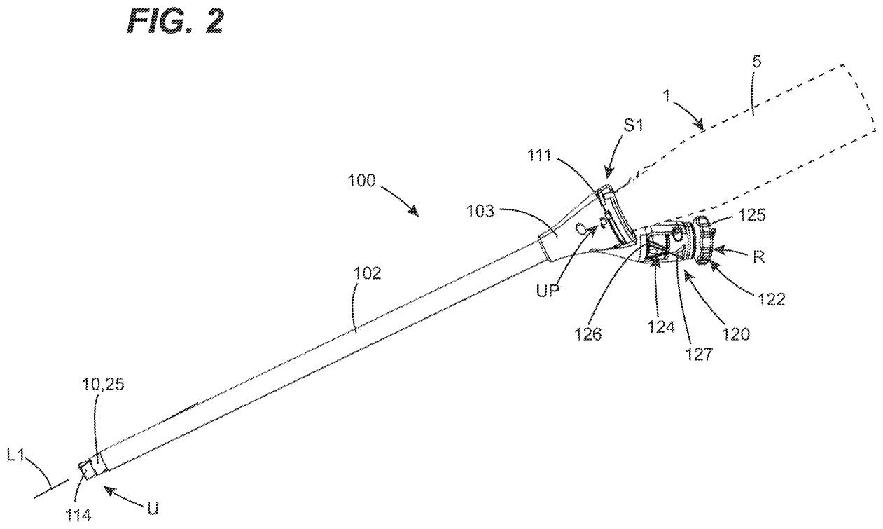

FIGS. 2-7 illustrate various aspects of an imaging element cleaning apparatus configured in accordance with one or more embodiments of the disclosures made herein, which is designated as cleaning apparatus 100. Cleaning apparatus 100 is preferably, but not necessarily, configured to be used with commercially available endoscopes, such as endoscope 1 of FIG. 1 for cleaning an imaging element thereof (i.e., an imaging element cleaning apparatus). Examples of such commercially available endoscopes include, but are not limited to, endoscopes manufactured under brand names of Karl Storz, Linvatec, Olympus, Richard Wolf, Stryker and Intuitive Surgical (i.e., DaVinci). To this end, in preferred embodiments, cleaning apparatus 100 can be engineered as endoscope-specific for one or more given models of one or more manufacturers based on the dimensional attributes of such commercially available endoscopes. An underlying consideration of the manner in which the endoscope cleaning apparatus 100 is engineered for intended brands and/or models of endoscope is that there be a high level of dimensional precision between the endoscope and the cleaning apparatus. Such dimensional precision can be characterized to include both the inhibition of any unacceptable level of relative movement between the endoscope and the cleaning apparatus 100 and relative placement of key structural elements of the endoscope relative to those of the cleaning apparatus 100.

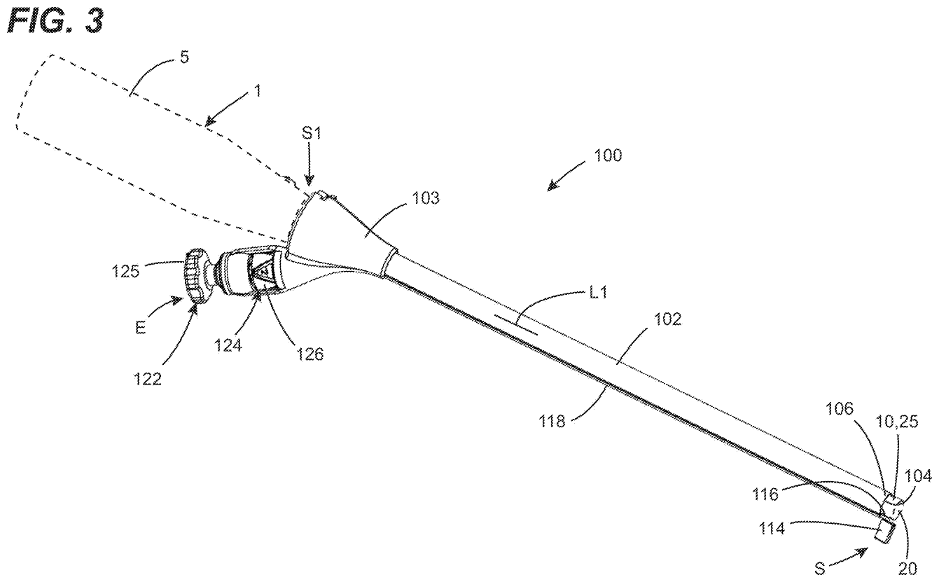

Still referring to FIGS. 2-7, the cleaning apparatus 100 has an elongated body 102 that is adapted to have the extension portion 10 of the endoscope 1 inserted therein. In a fully seated placement, as nest shown in FIGS. 2 and 3, a dimensionally predictable surface or feature of the endoscope 1 such as that of the user interface portion 5 (e.g., a handle and/or optic interface portion) abuts a mating dimensionally predictable surface or feature of the endoscope cleaning apparatus 100. This mating surface or feature of the cleaning apparatus 100—such as a surface or feature of a user interface body 103 thereof—serves as a reference structure of the cleaning apparatus 100. With the endoscope 1 in this fully seated position on the cleaning apparatus 100 with respect to the reference structure, a distal end portion 25 of the endoscope 1 protrude from within an opening 104 in the distal end portion 106 of the elongated body 102 by a known, predictable amount. Through such an interfacial arrangement and dimensional tolerances, a high level of dimensional precision between the endoscope 1 and the cleaning apparatus 100 can be achieved. As discussed below in greater detail, such dimensional precision is beneficial to the cleaning performance afforded by the cleaning apparatus 100.

As discussed above in reference to FIG. 1, the distal end portion 25 of the endoscope 1 carries the imaging element 20 (e.g., a lens). The imaging element 20 is exposed at and is generally flush with or defines an end face at the distal end portion 25 of the extension portion 10 of the endoscope 1. The distal end portion 25 of the endoscope 1 is exposed at the opening 104 in the distal end 106. As a result of the seated placement of the endoscope 1 on the cleaning apparatus 100, the imaging element 20 is at a known and predictable position relative to the reference structure of the cleaning apparatus 100. Thus, for an endoscope engineered for use with a specific cleaning apparatus, the components of the cleaning apparatus 100 can similarly be at known and predictable position relative to structures of the endoscope 1, thereby providing for precise placement and configuration of components of the cleaning apparatus 100 to achieve a desired and predictable level of cleaning performance.

The elongated body 102 and the user interface body 103 jointly define a chassis of the cleaning apparatus. The chassis serves as the platform on which the endoscope 1 can be mounted in a predictable seated position. It is disclosed herein that the chassis can be that of a robot that provides robot-assisted surgery or can be adapted to operatively interface with a mating mounting portion of such a robot. For example, the elongated body 102 and/or the user interface body 103 can be that of an arm or other structure of the robot or adapted to operatively interface with an instrument mounting portion of the arm of the robot.

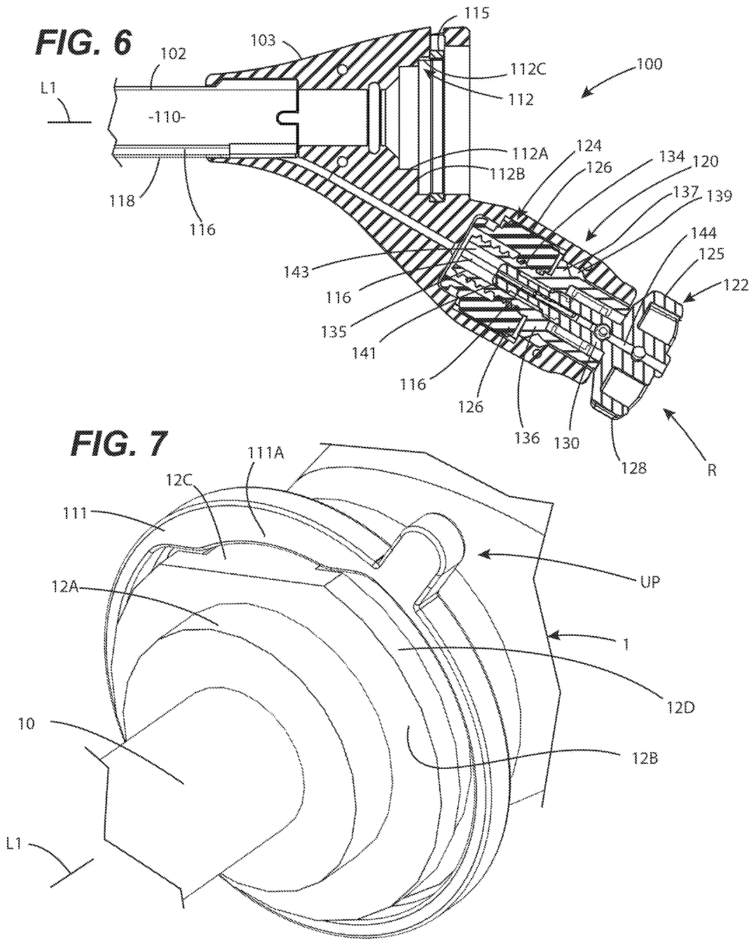

The elongated body 102 of the chassis can be a tube (e.g., a sheath) having a central passage 110 (shown in FIG. 6) with a round or generally round cross-sectional shape. Alternatively, the elongated member 102 can be a non-tubular structure such as a skeletal structure that engages the extension portion 10 of the endoscope at discrete spaced-apart locations thereof. The central passage 110 has a size and profile that is adapted to have the extension portion 10 of the endoscope 1 seated therein by inserting the extension portion 10 into the central passage 110 and sliding the extension portion 10 along the length of the elongated body 102 until the endoscope 1 is in a seated position S1 on the chassis. The user interface body 103 can include a retention member 111 for securing the endoscope 1 is in the seated position on the chassis.

The chassis can include a plurality of structural elements that provide for the known and predictable position of the endoscope 1 when mounted in a seated position on the chassis. One of these structural elements is the effective inside diameter (e.g., for ribbed or textured interior surface) or the actual inside diameter (e.g., a smooth interior wall) of the elongated body 102 in relation to an outside diameter of the extension portion 10 of the endoscope 1 and the elongated body 102 of the chassis. It is preferable to maintain a close fit between the outside wall of elongated body 102 and the mating exterior wall of the extension portion 10 so as to provide for a fluid-resistant interface between the elongated body 102 and the extension portion 10 and to limit off-axis pitch between a longitudinal axis of the elongated body 102 and the extension portion 10.

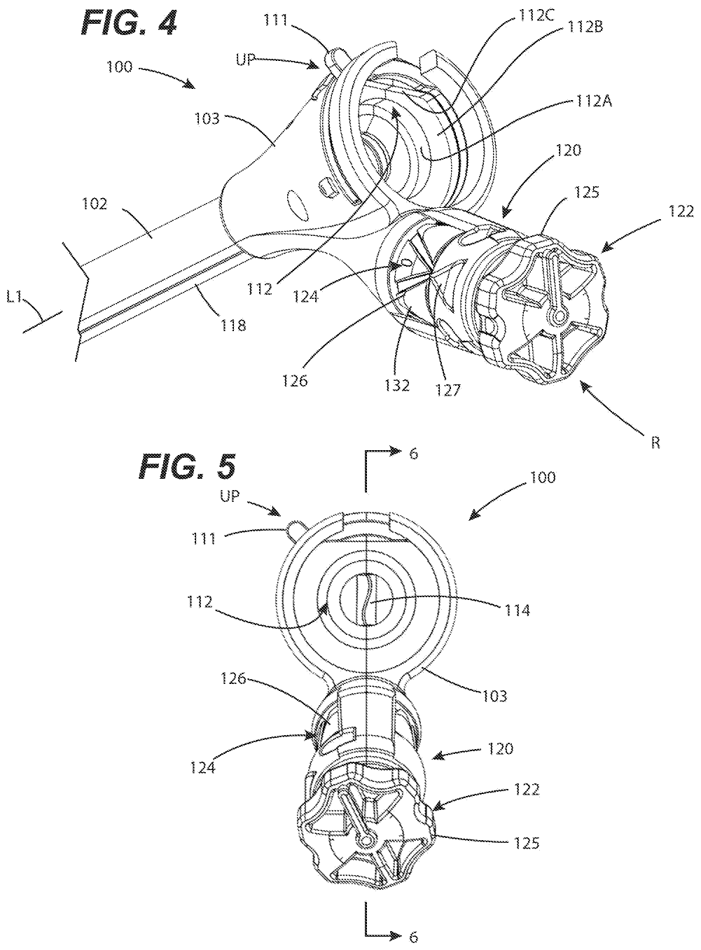

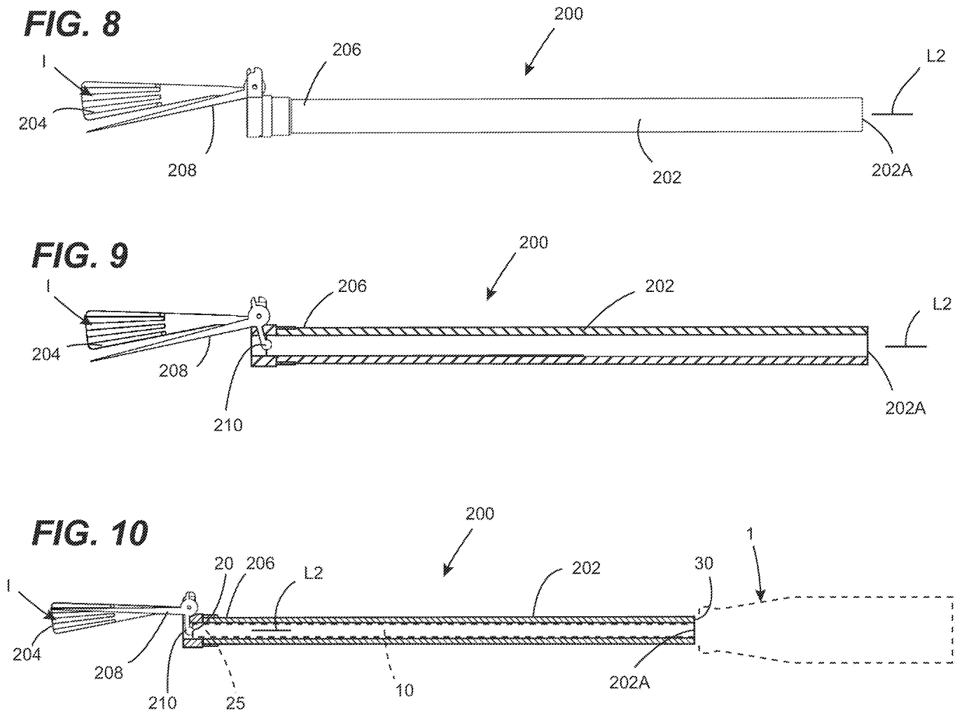

Another one of these structural elements is a seating structure 112 (best shown in FIGS. 4, 6, and 12) on the user interface body 103. In some embodiments, the seating structure 112 can include a first surface 112A that engages a mating first surface 12A of the scope 1, a second surface 112B that engages a mating second face surface 12B of the scope 1, and a third surface 112C that engages a mating third surface 12C of the scope 1. The first surface 112A may be an interior cylindrical surface that serves to define alignment of the scope 1 radially relative to a centerline longitudinal axis L1 of the elongated body 102 (i.e., limiting radial movement relative to the cleaning apparatus calibration device shown in FIG. 8). The second surface 112B is a planar surface (e.g., extending perpendicular to the centerline longitudinal axis L1) that serves to define positioning of the scope 1 axially relative to the centerline longitudinal axis L1 of the elongated body 102. The third surface 112C is a planar surface (e.g., extending tangentially offset from the centerline longitudinal axis L1) that serves to define positioning of the scope 1 angularly (i.e., anti-rotationally) relative to the centerline longitudinal axis L1 of the elongated body 102. The first surface 112A may be that of a cylindrical recess bound at the top by the second surface 112B. The third surface may be a flat planar surface that extends offset from and parallel to the centerline longitudinal axis L1. In these regards, the seating structure 112 positions the scope 1 in a predictable seated orientation (i.e., a known reference configuration/position) relative to the elongated body 102 and the user interface body 103.

The retention member 111 is moveably mounted on the interface body 103 for enabling the endoscope 1 to be selectively secured to the cleaning apparatus 100 in the aforementioned predictable seated orientation. The retention member 111 is disposed within a channel 115 of the user interface body 103 and is movable (e.g., manually movable about the centerline longitudinal axis L1) between an unlocking position UP and a locking position LP. In the unlocking position UL, the scope 1 may be engaged with (i.e., predictable seated orientation) and disengaged from the cleaning apparatus 100. In the locking position LP, the scope 1 is in secured engagement (i.e., predictable seated orientation) with the cleaning apparatus 100. For example, as best shown in FIG. 7, when the retention member 111 is in the unlocking position UP, a scope engagement portion 111A of the retention member 111 is in a mating portion of the third surface 12C of the scope 1 to thereby provide clearance with the mating portion of the third surface 12C of the scope 1 for permitting the scope 1 to be engaged with and disengaged from the cleaning apparatus 100. When the retention member 111 is in the locking position LP, the scope engagement portion 111A of the retention member 111 abuts (i.e., lies in front of) a flange 12D of the scope 1 that defines the second surface 12B of the scope 1, thereby inhibiting the scope 1 from being is engaged from engagement with the cleaning apparatus 100.

The cleaning apparatus 100 includes a cleaning member 114 (shown in FIGS. 2 and 3) adjacent to the opening 104 in the distal end portion 106 of the elongated body 102. The anti-rotation functionality discussed above in reference to the seating structure 112 serves to define angular positioning (clocked position) of the scope 1 relative to the cleaning member 114 about the centerline longitudinal axis L1. As discussed below in greater detail, the cleaning member 114 functions to clean contaminants and debris from an exterior surface of the imaging element 20 when brought into contact with the imaging element 20. The cleaning member 114 can be fixedly attached to a distal end portion of a coupling element 116. As best shown in FIGS. 3 and 6, the coupling element 116 may extend through a central passage of a channel 118 of the elongated body 102. Preferably, the central passage of the channel 118 and the central passage 110 of the elongated body 102 extend parallel to each other.

In some embodiments, the coupling element 116 is characterized by an elongated small diameter structure that offers at least a limited degree of bendability in combination with high torsional rigidity. In other embodiments, the coupling element 116 is characterized by an elongated small diameter structure that offers a given amount of torsional compliance. Based on these characterizing attributes, examples of coupling element 116 include, but are not limited to, solid metallic wire, spiraled metal wire, a polymeric filament(s), a composite filament(s), or the like.

The user interface body 103, which can be configured as a handle for the cleaning apparatus 100, carries a cleaning member controller 120. The cleaning member controller 120 is coupled to the user interface body 103 and to the cleaning member 114 for enabling selective movement of the cleaning member 114 relative to the elongated member 102. The cleaning member controller 120 includes a first cleaning member control mechanism 122 (i.e., a cleaning member movement mechanism) and a second cleaning member control mechanism 124 (i.e., a cleaning member adjusting mechanism). The first cleaning member control mechanism 122 includes a control body 125 (i.e., the first control body 125) that is rotatably and translatably mounted on (i.e., attached to) the user interface body 103, as best shown in FIG. 6 and the second cleaning member control mechanism 124 is rotatably mounted on the user interface body 103. The first and second cleaning member control mechanisms 122, 124 provide for various cleaning member manipulation modes.

Through such movement capability of the first cleaning member control mechanism 122, the first cleaning member control mechanism 122 provides at least a first cleaning member manipulation mode and a second cleaning member manipulation mode. The first cleaning member manipulation mode may include translational movement, as provided for by translation of the coupling element 116 to move the cleaning member 114 between a use position U (best shown in FIG. 2) and a stowed position S (best shown in FIG. 3)—i.e., the first cleaning member manipulation mode. As can be seen, the stowed position S and the use position U are relative to a location of the imaging element 20 of the endoscope 1 when the endoscope 1 is mounted on the chassis. The use position U is a position in which the cleaning element 114 is beyond a terminal end of the endoscope 1. The stowed position S is a position in which the cleaning element 114 is retracted from the use position U (e.g., by a maximum distance of travel therebetween) such that the cleaning element 114 is out of the field of view of the endoscope 1. The second cleaning member manipulation mode may include rotational movement to move the cleaning member 114 into and away from contact with the imaging element 20 (i.e., wiping action across the imaging element 20 of the endoscope) while the cleaning member 114 is in the use position U—i.e., the second cleaning member manipulation mode. To this end, the coupling element 116 is fixedly attached to the cleaning member 114 and to the first control knob 125—i.e., inhibiting relative movement therebetween. In these manners, the first cleaning member manipulation mode of the first cleaning member control mechanism 122 permits manipulation of the cleaning member 114 for enabling in vivo cleaning of the imaging element 20 in concert with in vivo surgical cavity visualization as provided for by the imaging element 20.

As discussed above, the cleaning apparatus 100 and the endoscope 1 are jointly configured such that the imaging element 20 is at a known and predictable position relative to the reference structure of the chassis of the cleaning apparatus 100. Thus, due to dimensional properties of the endoscope 1 and the cleaning apparatus 100, the cleaning member 114 is at a known and predictable position relative to the imaging element 20. In at least one aspect, such known and predictable position of the cleaning member 114 relative to the imaging element 20 can be characterized as being an axial distance between a reference portion of the cleaning member 114 (e.g., a cleaning edge portion of the cleaning member 114) and the exposed surface of the imaging element 20. The axial distance may be an interference distance that results in interference between the cleaning member 114. The axial distance is a design parameter of the cleaning apparatus that enables the cleaning member 114 to remove (i.e., clean) debris and contaminants from the exposed surface of the imaging element 20 in response to the cleaning member 114 being moved into contact with (e.g., wiped across) the exposed face of the imaging element 20 during implementation of the second cleaning member manipulation mode when the cleaning member 114 is in the use position U.

Some situation can arise that influence the position of the cleaning member 114 relative to the imaging element 20 to a degree that can impair desired cleaning of the imaging element 20 is the use position U was non-adjustable. One such situation is where dimension tolerances of the cleaning apparatus 114 and and/or the endoscope 1 result in a dimensional stack that influence the axial distance between the reference portion of the cleaning member 114 and the exposed surface of the imaging element 20 to a degree that adversely effects cleaning performance—e.g., insufficient or excessive engagement of the cleaning member 114 and the imaging element 20. For example, the extension portion 10 of the endoscope 1 can have a length that is at the lower end of its tolerance range and the mating reference surface 12B of the endoscope 1 can be at the upper end of its tolerance range. In this case, the axial distance between the reference portion of the cleaning member 114 and the exposed surface of the imaging element 20 can become greater or less than required for providing acceptable cleaning performance.

Advantageously, cleaning apparatuses configured in accordance with one or more embodiments of the disclosures made herein may include at least one provision for mitigating situations that can influence the position of the cleaning member 114 relative to the imaging element 20 to a degree that impairs desired cleaning of the imaging element 20. To this end, the second cleaning member control mechanism 124 provides a respective cleaning member manipulation mode—i.e., a third cleaning member manipulation mode—for selectively altering the axial distance between the reference portion of the cleaning member 114 (e.g., the wiping edge) and the exposed surface of the imaging element 20.

As shown in FIGS. 2-6, the second cleaning member control mechanism 124 includes a control body 126 that is rotatably (i.e., moveably) attached to the first cleaning member control mechanism 122. Through rotation of the second control body 126 in a given direction, a respective change in the axial distance between the cleaning member 114 and the exposed surface of the imaging element 20 occurs (e.g., clock-wise rotation provides lesser distance and counter clock-wise rotation provides greater distance or vice-versa). In this manner, an end user is able to alter the axial distance between the cleaning member 114 and the exposed surface of the imaging element 20 to affect cleaning member loading upon contact with the imaging element 20 and thus affect imaging element cleaning performance.

Referring now, to FIG. 6, aspects of a specific implementation of the first and second cleaning member control mechanisms 122, 124 are disclosed. The first control body 125 includes a user interface portion 128 and a mounting portion 130 connected to the user interface portion 128. The mounting portion 130 is translatably and rotatably attached to a mating portion of the user interface body 103 to permit the first control body 125 to be axially translated relative to the user interface body 103 between a retracted position R (FIG. 2) and an extended position E (FIG. 3) for correspondingly moving the cleaning member 114 between the use position U and the stowed position S, and to be rotationally translated relative to the user interface body 103 for correspondingly moving the cleaning member 114 into and away from contact with the imaging element 20 of the endoscope 1. Dimensions of the mounting portion 130 and the mating passage of the user interface body 103 may jointly define the amount of translational movement that the cleaning member control mechanism 122 exhibits.

As best seen in FIG. 6, the second control body 126 is engaged with the user interface body 103 and the first cleaning member control mechanisms 122 for permitting rotation relative to the user interface body 103 and inhibiting axial translation relative to the user interface body 103. The second control body 126 includes a user interface portion 132 (e.g., an expose and user-accessible exterior surface) that enables a user to manually rotate the second control body 126 between selected rotational positions. A threaded interior portion 134 of the second control body 126 is threadedly engaged with a mating threaded portion 135 of a coupling body 136. Such threaded engagement is an example of interlocked engagement, whereby axial movement is a function of rotational movement. The first control body 125 is engaged with the coupling body 136 to permit rotational and axial movement therebetween.

The coupling body 136 is engaged with the user interface body 103 to permit axial translation of the coupling body 136 relative to the user interface body 103 while inhibiting rotational movement therebetween such as via one or more shoulders 137 of the coupling body 136 being captured within a respective elongated channel 139 of the user interface body (i.e., a translation-enabling, rotation-inhibiting interface). A coupling body engaging portion 141 of the first control body 125 is disposed within a central passage 143 of the coupling body 136 to permit axial and rotational translation between the coupling body 136 and the coupling body engaging portion 141 of the first control body 125 (i.e., a rotation and translation enabling interface). For example, the coupling body engaging portion 141 and the central passage 143 of the coupling body 136 may have round cross-sectional shapes thereby enabling relative rotational and axial translation between the coupling body 136 and the coupling body engaging portion 141. A proximate end portion of the coupling element 116 extends through the central passage 143 of the coupling body 136 into a coupling element passage 144 of the coupling body engaging portion 141 of the first control body 125. The first control body 125 includes a securement means or structure for securing the proximate end of the coupling element 116 in a fixed placement relative to the first control body 125.

Through the threaded engagement between the second control body 126 and the coupling body 136, as discussed above, rotation of the second control body 126 relative to the coupling body 136 causes axial translation of the coupling body 136 relative to the first control body 125 and, thus, provides a corresponding axial adjustment of the use position U of the cleaning element 114. In this manner, adjustment of the axial distance between the reference portion of the cleaning member 114 and the exposed surface of the imaging element 20 when the cleaning member is in the use position U is provided (e.g., clock-wise rotation moves the cleaning member 114 closer to the distal end portion 106 of the elongated body 102 when the first control body 125 is in the retracted position R and counter clock-wise rotation moves the cleaning member 114 away from the distal end portion 106 of the elongated body 102 when the first control know is in the retracted position R or vice-versa).

A user can use the cleaning member adjustment capability provided by the second cleaning member control mechanism 124 in any number of ways. In one embodiment of use, a user can set-up an initial degree of contact between the cleaning element 114 and the imaging using such cleaning member adjustment capability to “preload” the cleaning member against the imaging element 20. For example, after mounting an endoscope on a chassis of the cleaning apparatus, the user can adjust the axial distance between the cleaning member 114 and the imaging element 20 such that the is no contact between the cleaning member 114 as the cleaning member 114 passes across the exposed surface of the imaging element 20. Using the cleaning member adjustment capability provided by the second cleaning member control mechanism 124, the user can then bring the cleaning element 114 into first contact with the imaging element 20 and then apply a given degree of “preload” to the cleaning member through use of the cleaning member adjustment capability. The cleaning member adjustment capability can also be utilized during the surgical procedure to further adjust the cleaning member axial distance (i.e., a greater or lesser contact loading on the cleaning member 114) to influence cleaning performance.

Referring to FIGS. 8-10, a user can set-up an initial degree of contact between the cleaning element 114 and the imaging element 20 using such cleaning member adjustment capability in combination with a cleaning apparatus calibration device 200—i.e., jointly an imaging element cleaning apparatus system. The cleaning apparatus calibration device 200 engages with a visualization scope (e.g., the endoscope 1) to provide a setting parameter upon an axial use position of a cleaning member of a cleaning apparatus in accordance with one or more embodiments of the disclosures made herein may be set. To this end, a cleaning apparatus in accordance with one or more embodiments of the disclosures made herein may include a cleaning member control mechanism having axial position setting indicia corresponding to the setting parameters of the cleaning apparatus calibration device 200—i.e., the axial position setting indicia of the cleaning member control mechanism enables axial positioning of the cleaning member of an imaging element cleaning apparatus to be set as a function of a setting parameter provided by the cleaning apparatus calibration device 200 for a particular endoscope that is to be used with the imaging element cleaning apparatus.

In one embodiment, the cleaning apparatus calibration device 200 includes a chassis 202, an indicia body 204, and an indicator body 208. The chassis 202 may include a longitudinal reference axis L2 and an imaging element contacting surface of the imaging element engagement portion 210 may be located on or adjacent to the longitudinal reference axis L2. The chassis 202 may include a sheath having a central passage adapted to receive an extension portion of the endoscope (e.g., simulating the elongated body of a cleaning apparatus in accordance with one or more embodiments of the disclosures made herein) and the imaging element contacting surface of the imaging element engagement portion 210 may be located within the central passage of the sheath or adjacent to an open end of the sheath through which the central passage of the sheath is accessible.

The indicia body 204 may be fixedly attached to a distal end portion 206 of the chassis 202 and an indicator body 208 moveably (e.g., pivotably) is attached to the indicia body 204 (and/or optionally the chassis 202) for enabling the indicator body 208 to move (e.g., pivot) relative to the setting indicia body 204. The chassis 202 enables a distal end portion 25 of the extension portion 10 of the endoscope 1 (i.e., preferably the imaging element 20) to engage an imaging element engagement portion 210 of the indicator body 208 when a reference surface 30 of the endoscope 1 is engaged (seated) with a mating reference surface 202A of the chassis 202 to thereby cause the indicator body 208 to move to a corresponding position designating a respective one of the plurality of setting indicum I on the indicia body 204. The setting indicum I may be of any suitable form so as to convey a specific setting parameter—e.g., numbers, letters, shapes, colors, and the like. As shown, a number of lines over which the indicator body 208 indicates a numeric value passes corresponds to a respective instance of numeric value on the second control body 126 that is to be aligned with a reference indicator 127 on the user interface body 103—e.g., the indicator body 208 passing 3 lines on the indicia body 204 corresponds to numeric value “3” on the second control body 126 being aligned with the reference indicator 127. A pitch of the threaded interface between the first and second cleaning member control mechanisms 122, 124 correlate such indicator body 208 reading to a corresponding numeric value on the second control body 126.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

What is claimed is:

1. An imaging element cleaning apparatus, comprising:
a chassis adapted for having an endoscope engaged therewith, wherein the chassis includes an endoscope receptacle having an interior space configured to have a mating portion of the endoscope disposed therein, wherein the chassis includes an endoscope retention member selectively moveable between an endoscope locking position to engage a first mating portion of the endoscope for maintaining the endoscope in an axially seated configuration within the endoscope receptacle and an endoscope unlocking position to disengage from the first mating portion of the endoscope for permitting the endoscope to be removed from being axially seated within the endoscope receptacle, and wherein the chassis includes an endoscope anti-rotation structure that engages a second mating portion of the endoscope to secure the endoscope in a prescribed rotationally indexed position relative to the chassis when the endoscope in the axially seated configuration within the endoscope receptacle;
a cleaning member at a distal end portion of the chassis; and
a cleaning member controller at a proximate end portion of the chassis, wherein the cleaning member controller is coupled to the chassis and to the cleaning member for enabling selective movement of the cleaning member relative to the chassis.

2. The imaging element cleaning apparatus of claim 1 wherein:
the endoscope receptacle includes an upper end portion and a bottom end portion;
the endoscope retention member is located adjacent to the upper end portion; and
the endoscope anti-rotation structure is located adjacent to the bottom end portion.

3. The imaging element cleaning apparatus of claim 2 wherein the endoscope anti-rotation structure at least partially defines the bottom end of the endoscope receptacle.

4. The imaging element cleaning apparatus of claim 2 wherein an endoscope engagement portion of the endoscope retention member is located within an interior space of the endoscope receptacle.

5. The imaging element cleaning apparatus of claim 2 wherein:
the chassis includes an elongated body having a central passaged adapted to receive an extension portion of the endoscope therein; and
the endoscope retention member rotates about a centerline longitudinal axis of central passage of the elongated body.

6. The imaging element cleaning apparatus of claim 4 wherein:
the endoscope anti-rotation structure at least partially defines the bottom end of the endoscope receptacle; and
the bottom end of the endoscope receptacle includes a seating surface that engages the first mating portion of the endoscope to define the axially seated configuration of the endoscope relative to the chassis.

7. The imaging element cleaning apparatus of claim 6 wherein an endoscope engagement portion of the endoscope retention member is located within an interior space of the endoscope receptacle.

8. The imaging element cleaning apparatus of claim 1 wherein:
the endoscope anti-rotation structure at least partially defines a bottom end of the endoscope receptacle;
the bottom end of the endoscope receptacle includes a seating surface that engages the first mating portion of the endoscope to define the axially seated configuration of the endoscope relative to the chassis; and
an endoscope engagement portion of the endoscope retention member is located within an interior space of the endoscope receptacle.

9. The imaging element cleaning apparatus of claim 1 wherein:
the cleaning member controller includes a first cleaning member control mechanism and a second cleaning member control mechanism;
the first cleaning member control mechanism is translatably attached to the chassis to enable movement of the cleaning member between a stowed position and a use position relative to the location adjacent to the imaging element of the endoscope when the endoscope is mounted on the chassis;
the first cleaning member control mechanism is rotatably attached to the chassis to enable movement of the cleaning member into and away from contact with the imaging element; and
the second cleaning member control mechanism includes a control body rotatably attached to the first cleaning member control mechanism to provide for axial adjustment of the cleaning member relative to the chassis.

10. The imaging element cleaning apparatus of claim 9 wherein:
the control body includes a set of markings each identifying a respective axial position of the cleaning member relative to the first cleaning member control mechanism; and
the control body is rotatable to a plurality of axial adjustment positions each corresponding to a respective one of the markings becoming aligned with a reference indicator on the chassis.

11. The imaging element cleaning apparatus of claim 10 wherein:
the endoscope receptacle includes an upper end portion and a bottom end portion;
the endoscope retention member is located adjacent to the upper end portion; and
the endoscope anti-rotation structure is located adjacent to the bottom end portion.

12. The imaging element cleaning apparatus of claim 11 wherein the endoscope anti-rotation structure at least partially defines the bottom end of the endoscope receptacle.

13. The imaging element cleaning apparatus of claim 11 wherein an endoscope engagement portion of the endoscope retention member is located within an interior space of the endoscope receptacle.

14. The imaging element cleaning apparatus of claim 11 wherein:
the chassis includes an elongated body having a central passaged adapted to receive an extension portion of the endoscope therein; and
the endoscope retention member rotates about a centerline longitudinal axis of central passage of the elongated body.

15. An imaging element cleaning apparatus system, comprising:
a cleaning apparatus calibration device having a chassis, a setting indicia body fixedly attached to the chassis, and an indicator body moveably attached to at least one of the chassis and the setting indicia body for enabling the indicator body to move relative to the setting indicia body, wherein the chassis enables a distal end portion of an extension portion of an endoscope to engage an imaging element engagement portion of the indicator body when a reference surface of the endoscope is engaged with a mating reference surface of the chassis to thereby cause the indicator body to move to a corresponding position designating a respective one of a plurality of setting indicum on the setting indicia body; and
an imaging element cleaning apparatus including a chassis adapted for having the endoscope engaged therewith, a cleaning member at a distal end portion of the chassis, and a cleaning member controller at a proximate end portion of the chassis, wherein:
the cleaning member controller is coupled to the chassis and to the cleaning member for enabling selective movement of the cleaning member relative to the chassis;
the cleaning member controller includes a first cleaning member control mechanism and a second cleaning member control mechanism;
the first cleaning member control mechanism is translatably attached to the chassis to enable movement of the cleaning member between a stowed position and a use position relative to the location adjacent to the imaging element of the endoscope when the endoscope is mounted on the chassis;
the first cleaning member control mechanism is rotatably attached to the chassis to enable movement of the cleaning member into and away from contact with the imaging element;
the second cleaning member control mechanism includes a control body rotatably attached to the first cleaning member control mechanism to provide for axial adjustment of the cleaning member relative to the chassis;
the control body includes a set of markings each identifying a respective axial position of the cleaning member relative to the chassis;
each of the marking corresponds to a respective one of the setting indicum on the setting indicia body; and
the control body is rotatable to a plurality of cleaning member axial adjustment positions each corresponding to a respective one of the markings becoming aligned with a reference indicator on the chassis.

16. The imaging element cleaning apparatus system of claim 15 wherein:
the chassis includes a longitudinal reference axis; and
an imaging element contacting surface of the imaging element engagement portion is located on the longitudinal reference axis.

17. The imaging element cleaning apparatus system of claim 15 wherein:
the chassis includes a sheath having a central passage adapted to receive an extension portion of the endoscope therein; and
an imaging element contacting surface of the imaging element engagement portion is located one of within the central passage of the sheath and adjacent to an open end of the sheath through which the central passage of the sheath is accessible.

18. The imaging element cleaning apparatus system of claim 15 wherein:
the chassis includes an endoscope receptacle having an interior space configured to have a mating portion of the endoscope disposed therein;
the chassis includes an endoscope retention member selectively moveable between an endoscope locking position to engage a first mating portion of the endoscope for maintaining the endoscope in an axially seated configuration within the endoscope receptacle and an endoscope unlocking position to disengage from the first mating portion of the endoscope for permitting the endoscope to be removed from being axially seated within the endoscope receptacle; and
the chassis includes an endoscope anti-rotation structure that engages a second mating portion of the endoscope to secure the endoscope in a rotationally indexed position relative to the chassis when the endoscope in the axially seated configuration within the endoscope receptacle.

19. The imaging element cleaning apparatus system of claim 18 wherein:
the endoscope receptacle includes an upper end portion and a bottom end portion;
the endoscope retention member is located adjacent to the upper end portion; and
the endoscope anti-rotation structure is located adjacent to the bottom end portion.

20. The imaging element cleaning apparatus system of claim 18 wherein:
the chassis includes a sheath having a central passage adapted to receive an extension portion of the endoscope therein; and
an imaging element contacting surface of the imaging element engagement portion is located one of within the central passage of the sheath and adjacent to an open end of the sheath through which the central passage of the sheath is accessible.
